(19) United States
(12) Patent Application Publication
(10) Pub. No.: US 2010/0159059 A1
(43) Pub. Date: Jun. 24, 2010

(54) MOULD WITH MOBILE INTERMEDIATE SURFACE

(75) Inventor: Andrea Sensini, Potenza Picena (MC) (IT)

Correspondence Address: EGBERT LAW OFFICES, 412 MAIN STREET, 7TH FLOOR, HOUSTON, TX, 77002, US

(73) Assignee: EUROSUOLE S.P.A., Civitanova Marche (IT)

(21) Appl. No.: 12/600,998

(22) PCT Filed: Apr. 29, 2008
(86) PCT No.: PCT/EP08/03460

§ 371 Date: Nov. 19, 2009

(30) Foreign Application Priority Data
Jun. 4, 2007 (IT) MC2007A000114

(51) Int. Cl. B28B 1/24

(52) U.S. Cl. 425/457

(57) ABSTRACT

The present invention concerns a mould divided into three parts for the direct moulding of a membrane equipped with a series of suction cups having the particular shape of an open hourglass or of bellows or of a cylinder onto a support made of breathable, waterproof or hydrophilic material positioned on the intermediate mobile part of the mould which is pressed against the lower part of the mould during the moulding phase and raised after moulding has been completed thanks to a series of springs that bring it back to its original position permitting automatic removal of the moulded suction cups without damage to their particular shape.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention concerns a mould divided into three parts for the direct moulding of a membrane equipped with a series of suction cups having the particular shape of an open hourglass or of bellows or of a cylinder onto a support made of breathable, waterproof or hydrophilic material positioned on the intermediate mobile part of the mould which is pressed against the lower part of the mould during the moulding phase and raised after moulding has been completed thanks to a series of springs that bring it back to its original position permitting automatic removal of the moulded suction cups without damage to their particular shape.

2. Description of Related Art Including Information Disclosed Under 37 CFT 1.97 and 37 CFR 1.98.

Currently moulds for thermoplastic materials are composed of two elements: the hollow or lower part on which the shape to be transferred to the molten material poured into it is drawn; the cover or upper part which, after moulding has been completed, opens manually or mechanically in order to allow the removal of the moulded product.

Having to proceed to the moulding of a membrane for shoe soles equipped with suction cups having the particular shape of an open hourglass or of bellows or of a cylinder and characterised by extreme flexibility and softness, the current moulds do not permit, once moulding has been completed, the removal of the moulded shapes of the said suction cups without breaking or damaging them thus compromising the functionality of the membrane.

### DISCLOSURE OF INVENTION

It is an object of the present invention to realise a mould for the moulding of flexible thermoplastic material of a series of extremely flexible suction cups having the shape of an open hourglass or of bellows or of a cylinder for a membrane for shoe soles.

Further, it is an object of the present invention to enable the easy removal from the mould of the series of the membrane's suction cups having the shape of an open hourglass or of bellows or a cylinder after moulding.

Further, it is an object of the present invention to guarantee the perfect functionality of the moulded membrane suction cups having the shape of an hourglass or of bellows or of a cylinder.

Further, it is an object of the present invention to permit the moulding of the membrane with its suction cups preferably having the shape of an open hourglass or of bellows or of a cylinder directly onto the support made of hydrophilic or breathable and waterproof material spaced one from the other in order to make the shoe more comfortable in its overall use and in order to facilitate the perspiration of the foot.

Further, it is an object of the present invention to equip the intermediate mobile part of the mould with a series of grids to prevent the injected thermoplastic material from totally covering the surface of the support made of hydrophilic or breathable and waterproof material.

Further, it is an object of the present invention to ensure that the series of grids realised on the intermediate part of the mould positions the suction cups having the shape of an hourglass or of bellows or of a cylinder at the desired distance one from the other on the hydrophilic breathable and waterproof material so as to increase the breathability of the membrane.

Not the last object of the present invention is to obtain a membrane with suction cups having the shape of an open hourglass or of bellows or of a cylinder to be used as an accessory in shoe soles with technical specifications superior to similar membranes obtained using the moulds currently available on the market today.

### BRIEF SUMMARY OF THE INVENTION

The present application which concerns a mould divided into three parts, the upper part of which has the classical function of cover to the entire mould, the intermediate mobile part and lower part of which have the function, respectively, of moulding the suction cups having the shape of an hourglass or of bellows or of a cylinder directly onto the support made of breathable or hydrophilic and waterproof material around the various pins located at the desired distances in the lower part of the mould against which the intermediate mobile part is mechanically pressed during the moulding phase and from which, thanks to a series of springs, it is distanced after moulding thereby allowing the automatic and integral removal of the suction cups moulded in the shape of an open hourglass or of bellows or of a cylinder.

Further features and advantages of the invention shall be better understood from the description of a preferred but not exclusive embodiment of the present application, illustrated by way of indicative but non-limiting example in the accompanying drawings.

### BRIEF DESCRIPTION OF THE SEVERAL VIEWS OF THE DRAWINGS

FIG. 1 shows a cross-sectional upper perspective view of the mould that is the object of the present application;

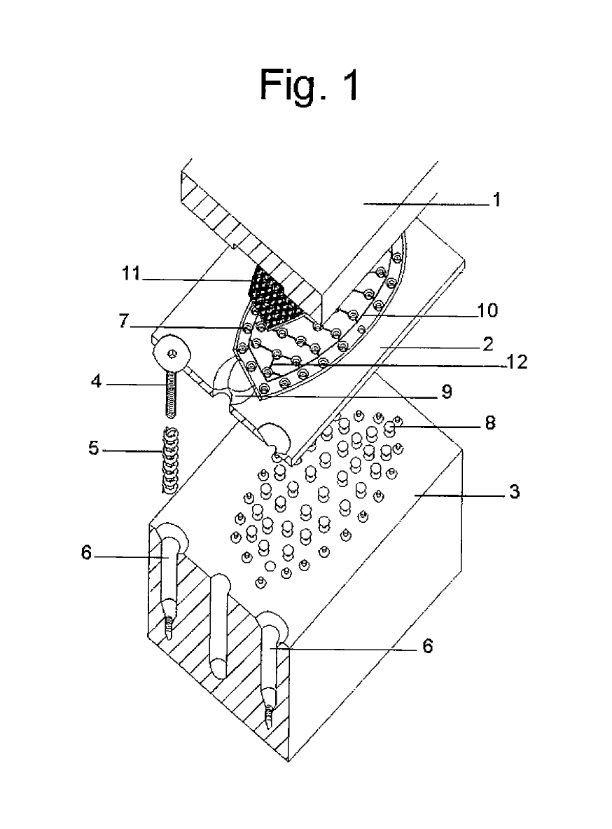

FIG. 2 shows a side cross-sectional view of the mould with the intermediate part open;

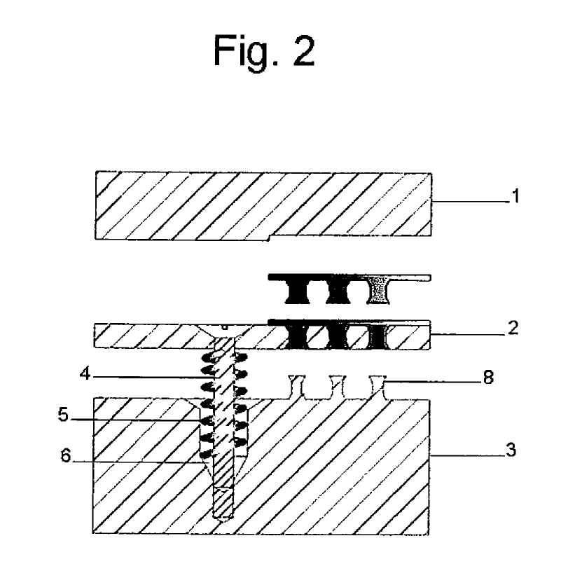

FIG. 3 shows a side cross-sectional view of the mould with the intermediate part closed;

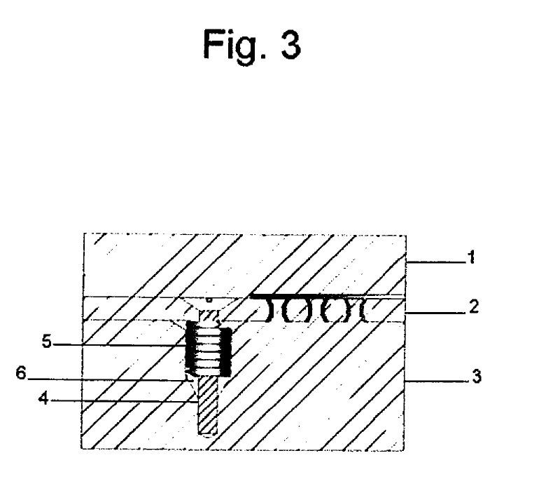

### DETAILED DESCRIPTION OF THE INVENTION

The invention that is the object of the present application is a mould composed of three sections, the upper part (1), the intermediate mobile part (2), the lower part (3). The intermediate mobile part (2) is detached from the lower part (3) of the mould and fastened to the same by means of a series of screws (4) fitted in specific seats (6) around which springs (5) are inserted to enable the intermediate mobile part (2) to close onto the lower part (3) due to mechanical pressure during the moulding phase through the infeeding of the thermoplastic material injected into the channel (9) and to return to its original position once moulding has been completed.

The thermoplastic material injected is fed into a series of grids (12) in the intermediate mobile part (2) so as to connect at the desired distance a number of holes (7) to an equivalent number of corresponding pins (8) in the shape of an hourglass or of bellows or of a cylinder located in the lower part (3) around which the suction cups are moulded directly onto the support made of hydrophilic or breathable material (11) placed beforehand on a perimeter line (10) of the upper area of the intermediate mobile part (2) of the mould.

In the resting position, the height of the intermediate mobile part (2) from the lower part (3) of the invention is more than proportional to the height of the pins (8) around which the suction cups having the shape of an open hourglass or of bellows or of a cylinder are moulded so that during the return movement the intermediate mobile part (2) can automatically disengage the suction cups leaving their moulded shapes intact.

The return movement of the intermediate mobile part (2) to its original position is determined by the joint functional combination of the relaxing of the mechanical pressure once moulding is completed and of the consequent lengthening of the springs (5) that push it upwards.

The materials and the dimensions of the above-described invention, illustrated in the accompanying drawings and later claimed, may be varied according to requirements. Moreover, all the details may be replaced by other technically equivalent ones without for this reason straying from the protective scope of the present invention patent application.

1. Mould with intermediate mobile surface for the direct moulding of a membrane as an accessory for shoe soles equipped with a series of suction cups preferably having the particular shape of an open hourglass or of bellows or of a cylinder moulded at a given distance one from the other onto a support made of breathable or hydrophilic and waterproof material, characterised by being divided into three parts, the upper part of which acts as the cover of the mould, the intermediate mobile part of which has the function of directly moulding the suction cups onto the previously positioned support made of hydrophilic or breathable and waterproof material, and the lower part of which has the function of shaping the suction cups through the pressure moulding of the intermediate mobile part on the pins located on the same from which they are automatically removed as a result of the upward movement of the intermediate mobile part determined by the joint functional combination of the relaxing of the mechanical pressure of the said intermediate mobile part of the mould once moulding has been completed and by its upward thrust due to the consequent lengthening of the springs with which the mould is equipped.

2. Mould with intermediate mobile surface as claimed in claim 1 the intermediate mobile part of which is characterised by being equipped with a vertical movement towards and from the lower part of the mould.

3. Mould with intermediate mobile surface as claimed in claim 1 characterised by the fact that the intermediate mobile part is fixed to the lower part by means of a series of screws located in specific seats around which the springs are fitted.

4. Mould with intermediate mobile surface as claimed in claim 1 characterised by the fact that the height separating the intermediate mobile part from the lower part is more than proportional to that of the pins located on the latter in order to ensure that the upward movement of the intermediate mobile part automatically disengages the suction cups having the shape of an open hourglass or of bellows or of a cylinder moulded around the pins through the return movement to its original position.

5. Mould with intermediate mobile surface as claimed in claim 1, the intermediate mobile part of which is characterised by having a number of holes equivalent to the number of corresponding pins located in the lower part of the mould in order to ensure that the suction cups having the shape of an open hourglass or of bellows or of a cylinder are moulded around them and at the desired distances.

6. Mould with intermediate mobile surface as claimed in claim 1, the intermediate mobile part of which is characterised by a series of grids which enable the injected material to reach the moulding holes of the suction cups, thereby preventing the entire hydrophilic or breathable and waterproof support onto which they are moulded from being covered by the material injected.

7. Mould with intermediate mobile surface as claimed in claim 1, characterised by the fact that the suction cups preferably having the shape of an open hourglass or of bellows or of a cylinder are moulded onto the support made of hydrophilic or breathable and waterproof material at a given distance one from the other thanks to a series of grids on the intermediate part of the invention, as claimed in claim 6.

8. Mould as claimed in claim 1, the intermediate mobile part of which is characterised by a perimeter line on which is inserted the support made of hydrophilic or breathable and waterproof material onto which the suction cups having the shape of an open hourglass or of bellows or of a cylinder are then moulded in flexible thermoplastic material.

9. Mould with intermediate mobile surface as claimed in claim 1, characterised by a system of screws that secures the intermediate mobile part to the lower part at a distance that is more than proportional to the length of the moulding pins of the moulded shapes of the suction cups located in the lower part of the invention.

10. Mould with intermediate mobile surface as claimed in claim 1, characterised by a system of springs located in specific spaces in the lower part of the mould which during the moulding phase brings the intermediate mobile into contact with the lower part through mechanical pressure and once moulding has been completed enables it to return to its original position so as to determine the easy and automatic removal of the suction cups having the shape of an open hourglass or of bellows or of a cylinder from the pins located on the lower part around which they have been moulded.
